(19) United States
(12) Patent Application Publication
(10) Pub. No.: US 2016/0284370 A1
(43) Pub. Date: Sep. 29, 2016

(54) THERMALLY-ASSISTED MAGNETIC RECORDING HEAD HAVING SEMICONDUCTOR SURFACE EMITTING LASER, AND HEAD GIMBAL ASSEMBLY AND DISK DRIVE UNIT WITH THE SAME

(71) Applicant: SAE Magnetics (H.K.) Ltd., Hong Kong (CN)

(72) Inventors: Seiichi TAKAYAMA, Hong Kong (CN); Takashi HONDA, Hong Kong (CN); Yasutoshi FUJITA, Hong Kong (CN); Osamu HARAKAWA, Hong Kong (CN); Ryuji FUJII, Hong Kong (CN)

(21) Appl. No.: 14/669,168

(22) Filed: Mar. 26, 2015

(51) Int. Cl. G11B 5/48

(52) U.S. Cl. CPC G11B 5/4866; G11B 2005/0021

(57) ABSTRACT

A thermally assisted magnetic head (TAMH) slider having an air bearing surface and a back surface opposite the air bearing surface, which includes a slider substrate, a magnetic head portion configured on the slider substrate and having a waveguide formed therein, a semiconductor surface emitting laser configured on the back surface with an emitting surface facing the back surface; and a lens configured between the semiconductor surface emitting laser and the waveguide for focusing lights emitted from the semiconductor surface emitting laser on an incident end of the waveguide. The TAMH slider has stable performance, and can rapidly write data to a magnetic recording medium with high recording density.

### FIELD OF THE INVENTION

The present invention relates in general to magnetic recording devices and more particularly to a thermally assisted magnetic head (TAMH) slider having a semiconductor surface emitting laser, a head gimbal assembly (HGA) and a disk drive unit with the same.

### BACKGROUND OF THE INVENTION

As the recording density of a magnetic recording device, as represented by a disk drive unit, becomes higher, further improvement has been required in the performance of a magnetic head and a magnetic recording medium, especially, in the magnetic recording medium. To increase the recording density of a magnetic recording device, it is necessary to decrease the size of the magnetic fine particles that constitute the magnetic recording medium. Making the magnetic fine particles smaller, however, causes the problem that the magnetic fine particles drop in the thermal stability of magnetization.

To solve this problem, it is effective to increase the anisotropic energy of the magnetic fine particles. However, increasing the anisotropic energy of the magnetic fine particles leads to an increase in anisotropic magnetic field (coercive force) of the magnetic recording medium. As a result, the magnetic head cannot write data to the magnetic recording medium when the anisotropic magnetic field of the medium exceeds the write field limit.

Recently, as a method for solving the problem of thermal stability, so-called a thermally assisted magnetic recording (TAMR) technique is proposed. In the technique, a magnetic recording medium formed of a magnetic material with a large anisotropic energy is used so as to stabilize the magnetization, then anisotropic magnetic field of a portion of the medium, where data is to be written, is reduced by heating the portion; just after that, writing is performed by applying write field to the heated portion. The area where data is written subsequently falls in temperature and rises in anisotropic magnetic field to increase the thermal stability of magnetization. Hereinafter, a magnetic head for use in TAMR will be referred to as a thermally assisted magnetic head (TAMH).

In this TAMR technique, there has been generally used a method in which a magnetic recording medium is irradiated and thus heated with a light such as near-field light. A known method for generating near-field light is to use a plasmon generator, which is a piece of metal that generates near-field light from plasmons excited by irradiation with light. The light for use to generate near-field light is typically guided through a waveguide, which is provided in the head, to the plasmon generator disposed near the medium facing surface, that is, a surface of the slider that faces the magnetic recording medium. However, from the beginning, more significant problem to be solved exists in how the light is to be supplied from a light source to the waveguide, and specifically, where and how the light source is to be disposed.

As disclosed in U.S. Patent Application Publication No. 2014/0241137 A1, for example, a laser diode is mounted on the back surface of a slider, and the light emitted from the laser diode is directly incident on the incident end of the waveguide provided in the slider for use to generate near-field light.

However, some laser light will be reflected back into the laser cavity following the propagation path, such as the interface between the emitting surface of the laser diode and the incident end of the waveguide, and the interface between the exit end of the waveguide and the ABS (air bearing surface) of the slider. The reflected light can get back into the laser cavity and cause laser mode hopping, that means a drop in the laser diode stability, which are changes in the laser wavelengths and corresponding changes in the laser power transferred to these wavelengths. Concretely, when the laser diode becomes unstable, the fluctuations in light output power and wavelengths occur, and eventually the fluctuations in writing signals occur. In addition, the light output power form the laser diode will become insufficient due to the fluctuations thereof, which may lead to increased heating time for the magnetic recording medium, or even is too insufficient to write data to the magnetic recording medium. Further, the wavelength fluctuation may cause that the laser light can not reach a desired position.

Hence, it is desired to provide a TAMH slider, a head gimbal assembly (HGA), and a disk drive unit to overcome the above-mentioned drawbacks.

### SUMMARY OF THE INVENTION

One objective of the present invention is to provide a thermally assisted magnetic head (TAMH) slider, which has stable performance, and can rapidly write data to a magnetic recording medium with high recording density.

Another objective of the present invention is to provide a head gimbal assembly (HGA) with a TAMH slider, which has stable performance, and can rapidly write data to a magnetic recording medium with high recording density.

Still one objective of the present invention is to provide a disk drive unit with a TAMH slider, which has stable performance, and can rapidly write data to a magnetic recording medium with high recording density.

The above objectives are achieved by providing a TAMH slider having an air bearing surface and a back surface opposite the air bearing surface, which includes a slider substrate, a magnetic head portion configured on the slider substrate and having a waveguide formed therein, a semiconductor surface emitting laser configured on the back surface with an emitting surface facing the back surface, and a lens configured between the semiconductor surface emitting laser and the waveguide for focusing lights emitted from the semiconductor surface emitting laser on an incident end of the waveguide.

Preferably, the semiconductor surface emitting laser is a vertical cavity surface emitting laser (VCSEL) or a photonic crystal surface emitting laser. Because the cavity length of the VCSEL is very short, so a stable longitudinal mode is available, and mode hopping would not happen, thereby the performance of the VCSEL is very stable. And the photonic crystal surface emitting laser is suitable for instability improvement, because of its very short cavity length, high power with single mode and difference of emitted lights direction and cavity direction.

Preferably, the lens is configured on the emitting surface.

Preferably, the lens is a Fresnel lens or a grating lens, optimally, the Fresnel lens.

Preferably, the centerlines of the waveguide, the semiconductor surface emitting laser and the lens are overlapped. Because the propagation path of the lights emitted from the semiconductor surface emitting laser is straight, so the light coupling efficiency and the light utilization efficiency is high.

Preferably, the incident end of the waveguide is embedded in the magnetic head portion with a predetermined distance between the incident end and the back surface.

As a first embodiment of the present invention, the lens is formed in the magnetic head portion. The lens formed in the magnetic head portion would not increase the total height of the TAMH slider.

As a second embodiment of the present invention, the lens and the semiconductor surface emitting laser are formed integrally, compared with the first embodiment, the second embodiment has lower manufacture cost and installation cost.

As a third embodiment of the present invention, the lens is defined as an individual element and formed between the back surface and the emitting surface of the semiconductor surface emitting laser. To facilitate installation, the lens is formed in an element, such as a frame element.

As a forth embodiment of the present invention, the lens and the semiconductor surface emitting laser are formed integrally, the incident end of the waveguide is extended to the back surface, and a transparent element is formed between the magnetic head portion and the lens in the semiconductor surface emitting laser. Although the total height of the slider becomes higher, but large emission area can be allowed.

As a fifth embodiment of the present invention, the incident end of the waveguide is extended to the back surface, and the lens is embedded in a transparent element that is formed between the magnetic head portion and the semiconductor surface emitting laser, with a predetermined spacing between the lens and the incident end kept.

As an embodiment of the present invention, the waveguide is in a shape of a bar, and the lens is constituted by a few concentric circular grooves.

As another embodiment of the present invention, the waveguide is flattened, and the lens is constituted by a few bar-shaped grooves.

Preferably, a focus of the lens and a center of an end face of the incident end are aligned horizontally.

A HGA, includes a suspension and a TAMH slider supported on the suspension, the TAMH slider having an air bearing surface and a back surface opposite the air bearing surface includes a slider substrate, a magnetic head portion configured on the slider substrate and having a waveguide formed therein, a semiconductor surface emitting laser configured on the back surface with an emitting surface facing the back surface, and a lens configured between the semiconductor surface emitting laser and the waveguide for focusing lights emitted from the semiconductor surface emitting laser on an incident end of the waveguide.

A disk drive unit, includes a HGA, a drive arm attached to the HGA, a disk, and a spindle motor to spin the disk, the HGA includes a suspension and a TAMH slider supported on the suspension, the TAMH slider having an air bearing surface and a back surface opposite the air bearing surface includes a slider substrate, a magnetic head portion configured on the slider substrate and having a waveguide formed therein, a semiconductor surface emitting laser configured on the back surface with an emitting surface facing the back surface, and a lens configured between the semiconductor surface emitting laser and the waveguide for focusing lights emitted from the semiconductor surface emitting laser on an incident end of the waveguide.

In comparison with the prior art, the TAMH slider uses a semiconductor surface emitting laser as a light source, the semiconductor surface emitting laser not only has high light output power, but also is suitable for instability improvement, because the cavity length thereof is very short and would not be affected by reflected light, moreover, the height thereof is much shorter than the conventional laser diode, which is beneficial for manufacturing smaller disk drive unit. In addition, a lens configured before the emitting surface of the semiconductor surface emitting laser serves as part of the front mirror of the semiconductor surface emitting laser, and has the function of inhibiting mode hopping by locking wavelength, then the stability of the semiconductor surface emitting laser is improved. In sum, the performance of the TAMH slider is stable, and the light output power is high, thus data can be rapidly written to a magnetic recording medium with high recording density.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a disk drive unit of the present invention;

FIG. 2 is a schematic view of a HGA and a disk of the present invention;

FIG. 3 is a schematic view of a TAMH slider according to the first embodiment of the present invention;

FIG. 4 is a schematic view of a lens in FIG. 3;

FIG. 5 is a top view of FIG. 3;

FIG. 6 is a cross-sectional view of a vertical cavity surface emitting laser of the present invention;

FIG. 7 is a perspective view of a photonic crystal surface emitting laser of the present invention;

FIG. 8 is a schematic view of a TAMH slider according to the second embodiment of the present invention;

FIG. 9 is a schematic view of a TAMH slider according to the third embodiment of the present invention;

FIG. 10 is a schematic view of a TAMH slider according to the forth embodiment of the present invention;

FIG. 11 is a schematic view of a TAMH slider according to the fifth embodiment of the present invention;

FIG. 12 is a schematic view of a lens according to a embodiment of the present invention;

FIG. 13 is a schematic view of a TAMH slider according to the sixth embodiment of the present invention, which applying the lens shown in FIG. 11;

FIG. 14 is a top view of FIG. 12.

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the present invention is directed to a TAMH slider, an HGA, and a disk drive unit with the same, the TAMH slider has stable performance, and can rapidly write data to a magnetic recording medium with high recording density.

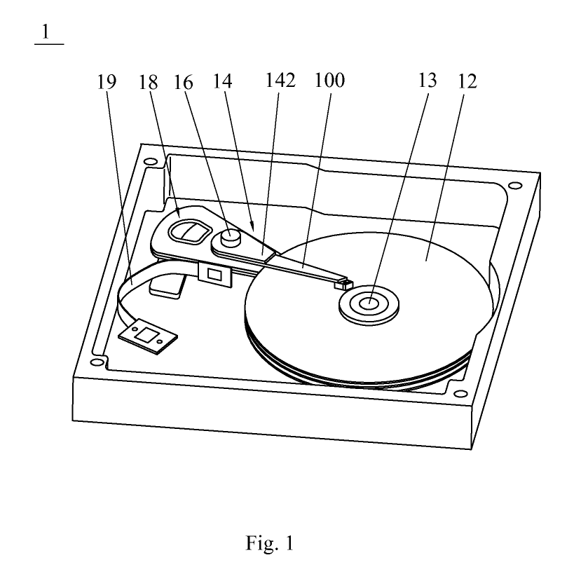

Referring to FIG. 1, a disk drive unit 1 contains a number of rotatable magnetic disks 12 attached to a spindle motor 13, and a head stack assembly (HSA) 14 which is rotatable about an actuator arm axis 16 for accessing data tracks on the magnetic disks 12 during seeking. The magnetic disk 12 is a type of magnetic recording medium. The HSA 14 contains a set of drive arms 142 and HGAs 100 mounted on the ends of the drive arms 142. Typically, a spindling voice-coil motor (VCM) 18 is provided for controlling the motion of the drive arm 142.

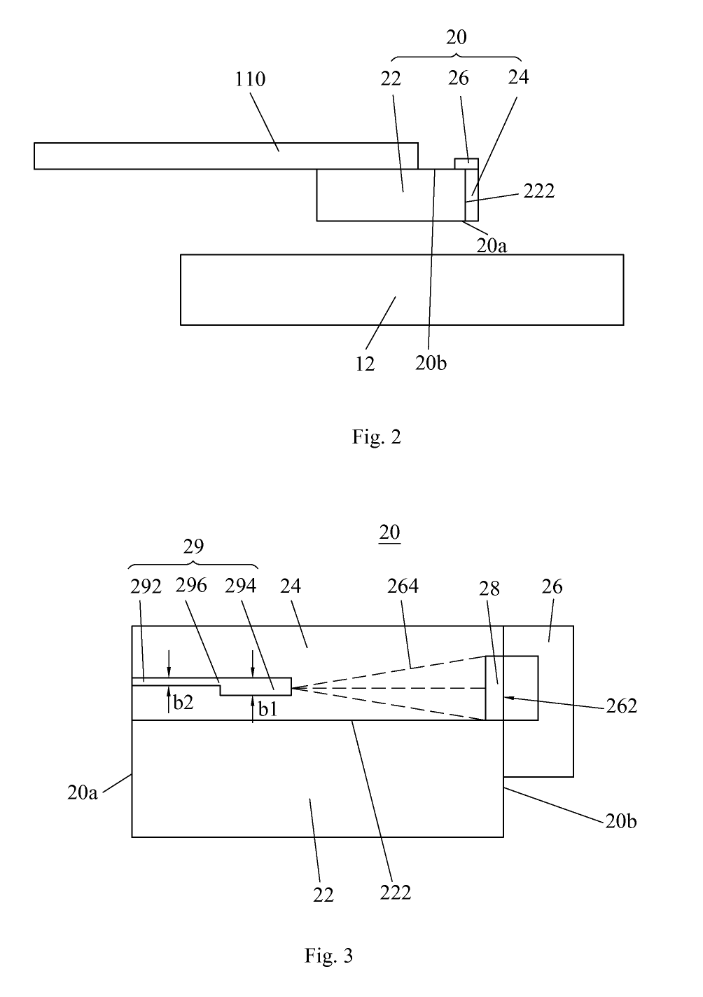

Referring to FIGS. 1 and 2, the HGA 100 contains a TAMH slider 20 and a suspension 110 supporting the TAMH slider 20. When the hard disk drive 1 is on, the spindle motor 13 will rotate the magnetic disk 12 at a high speed, and the TAMH slider 20 will fly above the magnetic disk 12 due to the air pressure drawn by the rotated magnetic disk 12. The TAMH slider 20 moves across the surface of the magnetic disk 12 in the radius direction under the control of the VCM 18. With a different track, the TAMH slider 20 can read data from or write data to the magnetic disk 12. Concretely, the magnetic disk 12 has high recording density, and the TAMH slider 20 write data to the magnetic disk 12 by a TAMR technique. Hereafter, the TAMH slider 20 will be described in detail.

FIG. 3 is a schematic view of a TAMH slider 20 according to the first embodiment of the present invention. As shown, the TAMH slider 20 has an air bearing surface (ABS 20a), that is a surface facing the magnetic disk 12, and a back surface 20b opposite the ABS 20a. Concretely, the TAMH slider 20 includes a slider substrate 22 with a trailing edge 222, and a magnetic head portion 24 with a write pole (not shown) configured on the trailing edge 222 of the slider substrate 22, that is, the slider substrate 22 constitutes a part of the ABS 20a, and the magnetic head portion 24 constitutes the other part of the ABS 20a. The TAMH slider 20 further includes a semiconductor surface emitting laser 26 configured on the back surface 20b, a lens 28, and a waveguide 29 having an exit end 292 and an incident end 294, the lens 28 and the waveguide 29 are formed in the magnetic head portion 24, as shown in FIG. 3.

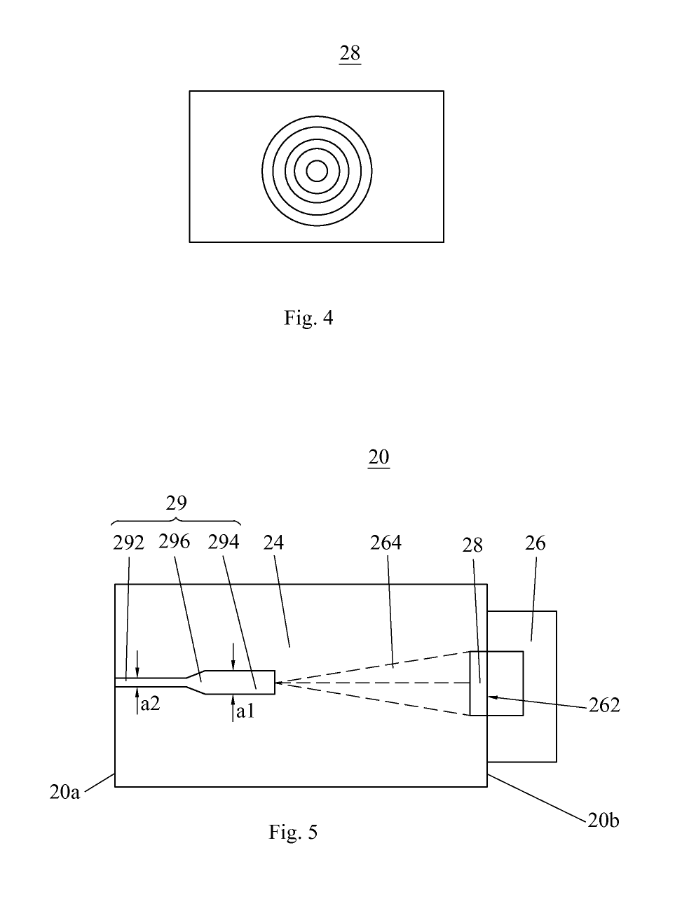

Concretely, as shown in FIG. 4, the semiconductor surface emitting laser 26 has an emitting surface 262, where lights 264 is emitted from, and the emitting surface 262 faces the back surface 20b. The lens 28 is formed in the magnetic head portion 24 and configured between the semiconductor surface emitting laser 26 and the waveguide 29, preferably, on the emitting surface 262, for focusing lights 264 emitted therefrom onto the incident end 294 of the waveguide 29. The lens 28 serves as part of the front mirror of the semiconductor surface emitting laser 26, and has the function of inhibiting mode hopping by locking wavelength, and then the stability of the semiconductor surface emitting laser 26 is improved. As shown, the incident end 294 of the waveguide 29 is embedded in the magnetic head portion 24 with a predetermined distance between the incident end 294 and the back surface 20b, concretely, the focus of the lens 28 is defined at a position in the middle of the magnetic head portion 24, due to the focusing function of the lens 28, the end face of the incident end 294 of the waveguide 29 can be deposed at the focus of the lens 28, preferably, the focus of the lens 28 and the center of the end face of the incident end 294 are aligned horizontally. And the exit end 292 of the waveguide 29 extends to the ABS 20a, so the waveguide 29 length is nearly a half that of the magnetic head portion 24. Again, the lights 264 incident into the waveguide 29 has been focused by the lens 28, so the inner diameter of the waveguide 29 can be decreased, as shown in FIG. 3, is much smaller than that of the emitting surface 262. Finally, the lights 264 emitted from the exit end 292 can heat the magnetic disk 12 that faces the ABS 20a, and then write pole can write data to the magnetic disk 12.

Further, the lens 28 is formed in the magnetic head portion 24, because the lens 28 and the magnetic head portion 24 are formed integrally, so the lens 28 would not increase the total height of the TAMH slider 20. Preferably, the lens 28 is a Fresnel lens or a grating lens, in the present invention, a Fresnel lens is used. Referring to FIG. 4, the lens 28 is constituted by a few concentric circular grooves, by this type of the lens 28, the lights 264 can be focus to a point, and thus the waveguide 29 can be in a shape of a thin bar. As for the principle of the lens 28, it is well-known and need not be repeated here. Concretely, referring to FIGS. 3 to 5, the incident end 294 and the exit end 292 of the waveguide 29 are respectively in a shape of a cuboid, but the cross-sectional area of the incident end 294 with a 4 μm length a1 and a 1 μm width b1 is comparatively larger than that of the exit end 292 with a 0.6 μm length a2 and a 0.4 μm width b2. The middle part 296 of the waveguide 29 is in a shape of a trapezoidal cuboid for connecting the incident end 294 and the exit end 292.

Preferably, the centerlines of the waveguide 29, the semiconductor surface emitting laser 26 and the lens 28 are overlapped. Because the propagation path of the lights 264 emitted from the semiconductor surface emitting laser 26 is straight, so the light coupling efficiency and the light utilization efficiency is high. If the centerlines of the waveguide 29 is not overlapped with that of the lens 28, the structure of the lens 28 just need to be changed to make the focus thereof onto the incident end 294, such as changing the concentric circular grooves to oval grooves.

Preferably, a plasmon generator (not shown) is disposed near the ABS 20a, which generates near-field light from plasmons excited by irradiation with lights 264. The lights 264 for use to generate near-field light is guided through the waveguide 29, and the near-field light is used to irradiate and then heat the magnetic disk 12 with high recording density, and then writing is performed by write pole to the heated portion. By the way, a TAMH slider 20 without the plasmon generator also can heat the magnetic disk 12 by the lights 264 guided through the waveguide 29 directly.

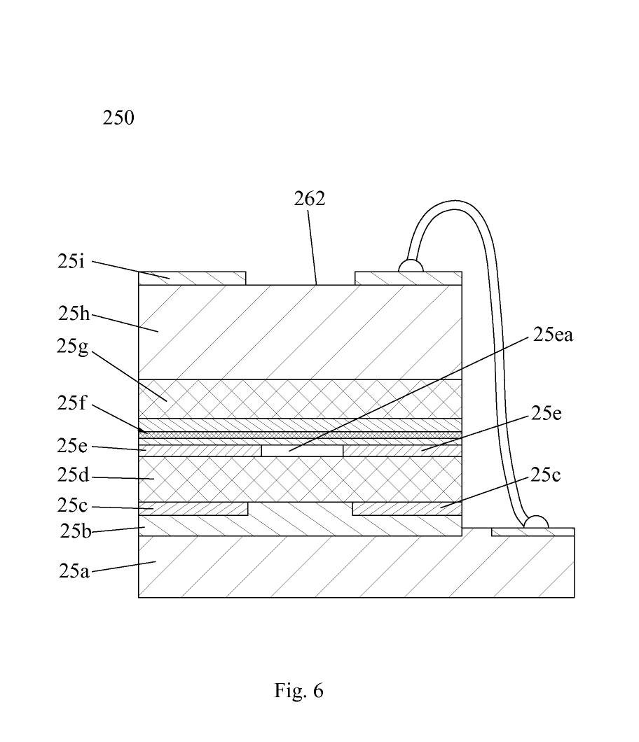

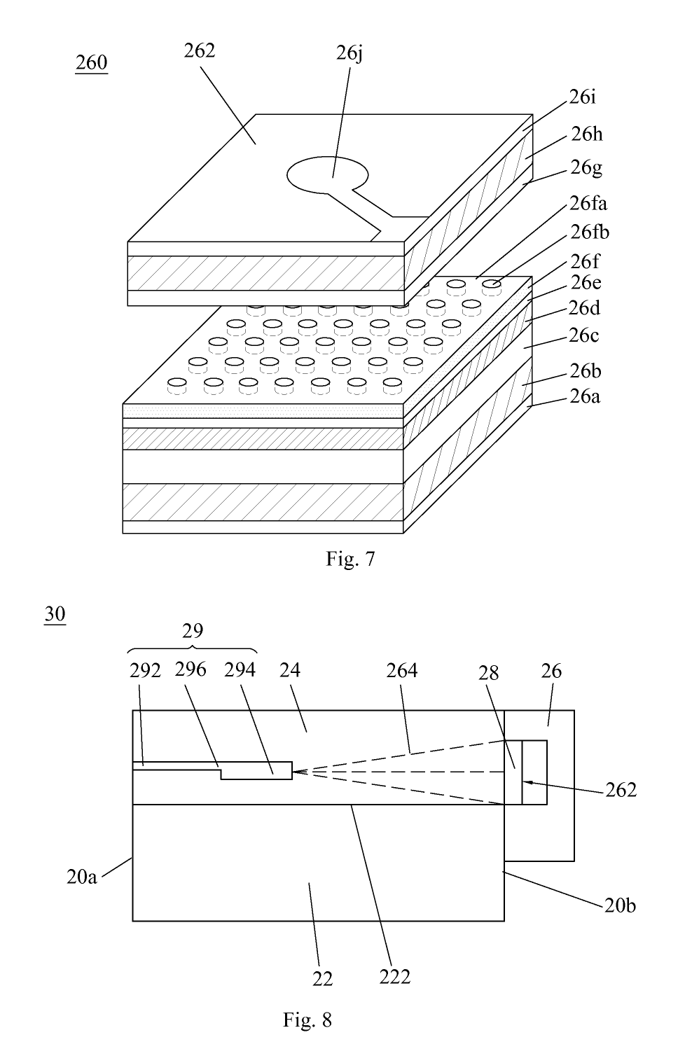

Concretely, the semiconductor surface emitting laser 26 is a vertical cavity surface emitting laser 250 (VCSEL, as shown in FIG. 6) or a photonic crystal surface emitting laser 260 (as shown in FIG. 7). Referring to FIG. 6, the VCSEL 250 includes a first substrate 25b formed on a heat-spreader 25a, a top DBR 25g and a bottom DBR 25d formed on the first substrate 25b, an active layer 25f sandwiched between the bottom DBR 25d and top DBR 25g to generate lights, and a second substrate 25h formed on the top DBR 25g. Concretely, a top electrode layer 25i is formed on the second substrate 25h and electrically connected with the heat spreader 25a, and a bottom electrode layer 25c is formed beneath the bottom DBR 25d, which are adapted for applying current to the active layer 25f to generate light. An emitting surface 262 is formed by opening a window in the top electrode layer 25i, so as to expose a part of the second substrate 25h. When a drive current is applied to the top and bottom electrode layers 25i and 25c, it flows through the active layer 25f, and then light is generated in the active layer 25f. Generally, the bottom and top DBRs 25d and 25g respectively are stacks of layers in different refractive index layers alternately stacked, and the light is amplified while it is reflected at each interface between layers of top DBR 25g and bottom DBR 25d, and is emitted from the emitting surface 262 of the VCSEL 250 vertically.

Preferably, a current limiting layer 25e formed between the active layer 25f and the bottom DBR 25d is used to direct the electrical current generally toward the middle of the active layer 25f. When used, the current limiting layer 25e insulates all but a circular or polygon-shaped window 25ea having a diameter being of the order of the diameter of the emitting surface 262. Because most of the electrical current is directed toward the middle of the active layer 25f, most of the light is generated within the middle portion of the active layer 25f. In addition, the cavity length of the VCSEL is very short, so a stable longitudinal mode is available, and mode hopping would not happen, thereby the performance of the VCSEL is very stable.

The structure of the photonic crystal surface emitting laser 260 will now be described following. Referring to FIG. 7, the photonic crystal surface emitting laser 260 has a multilayered structure including: an n-electrode 26a as an upper surface; a p-electrode 26j provided on the emitting surface 262; an n-clad layer 26b; a p-clad layer 26h; an active layer 26d for generating a light, provided between the n-clad layer 26b and the p-clad layer 26h; and a photonic-band layer 26f having a periodic structure in which the generated light resonates, provided between the active layer 26d and the p-clad layer 26h. A medium 26fa having the first refractive index nF1, a plurality of optical elements 26fb having the second refractive index nF2 different from the first refractive index nF1 are arranged two-dimensionally and periodically in the photonic-band layer 26f.

The photonic-band layer 26f has a periodic structure in which, in a medium 26fa having the first refractive index nF1, a plurality of optical elements 26fb having the second refractive index nF2 different from the first refractive index nF1 are arranged two-dimensionally and periodically. When a predetermined voltage is applied to between the n-electrode 26a and the p-electrode 26j, a light is generated by the recombination of an electron and a positive hole in the active layer. In the generated lights, a light having a wavelength comparable with (nearly equal to) the period of the periodic structure of the photonic-band layer 26f resonates within the layer 26f. Thus, only the light with wavelength and phase specified by the resonance proceeds in the direction perpendicular to a (two-dimensional periodic) plane 26fc in which the two-dimensional period of the photonic-band layer 26f lies (in the thickness direction). As a result, a light 264 of a single-mode, having a predetermined beam cross-section area and an extremely small divergence angle (an almost-collimated light) is emitted from the emitting surface 262 toward the lens 28 in the thickness direction.

Concretely, the p-electrode 26j is provided on the opposite side to the active layer 26d in relation to the p-clad layer 26h, through a contact layer 26i made of, for example, p-type GaAs. Further, a spacer layer 26c made of, for example, n-type GaAs is provided between the n-clad layer 26b and the active layer 26d, and a spacer layer 26e made of, for example, p-type GaAs is provided between the active layer 26d and the photonic-band layer 26f. Furthermore, a spacer layer 26g made of, for example, p-type GaAs is provided between the photonic-band layer 26f and the p-clad layer 26h.

In sum, the photonic crystal surface emitting laser 260 is suitable for instability improvement, because of very short cavity length of the optical elements 26fb, high power with single mode and difference of emitted light direction and cavity direction.

FIG. 8 is a schematic view of a TAMH slider 30 according to the second embodiment of the present invention, the TAMH slider 30 as shown is same with the TAMH slider 20 mentioned-above except for the lens 28. In this embodiment, the lens 28 and the semiconductor surface emitting laser 26 are formed integrally, that is, one side of the lens 28 contacts with the emitting surface 262 and the other side of the lens 28 contacts with the back surface 20b. Compared with the first embodiment, the second embodiment has lower manufacture cost ad installation cost.

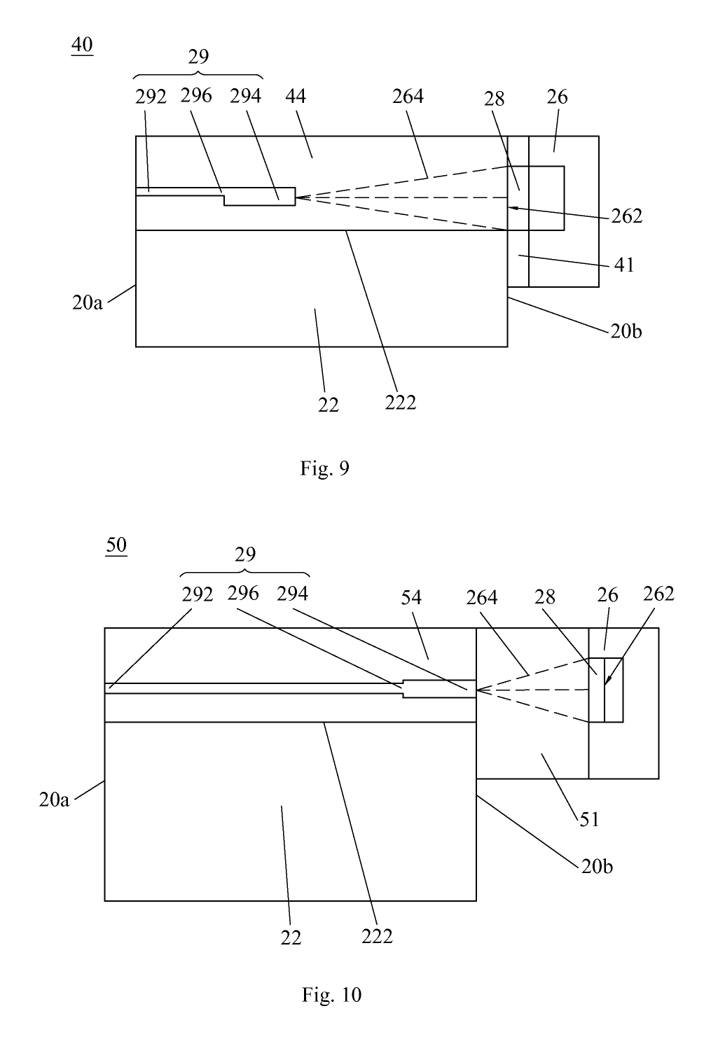

FIG. 9 is another schematic view of a TAMH slider 40 according to the third embodiment of the present invention, the lens 28 is defined as an individual element and formed between the back surface 20b and the emitting surface 262 of the semiconductor surface emitting laser 26. To facilitate installation, the lens 28 is formed in an element 41, such as a frame element.

FIG. 10 is still another schematic view of a TAMH slider 50 according to the forth embodiment of the present invention, the lens 28 and the semiconductor surface emitting laser 26 are formed integrally, a transparent element 51 is formed between the magnetic head portion 54 and the lens 28 formed in the semiconductor surface emitting laser 26, the incident end 294 of the waveguide 29 is extended to the back surface 20b. Although the total height of the slider becomes higher, but large emission area can be allowed.

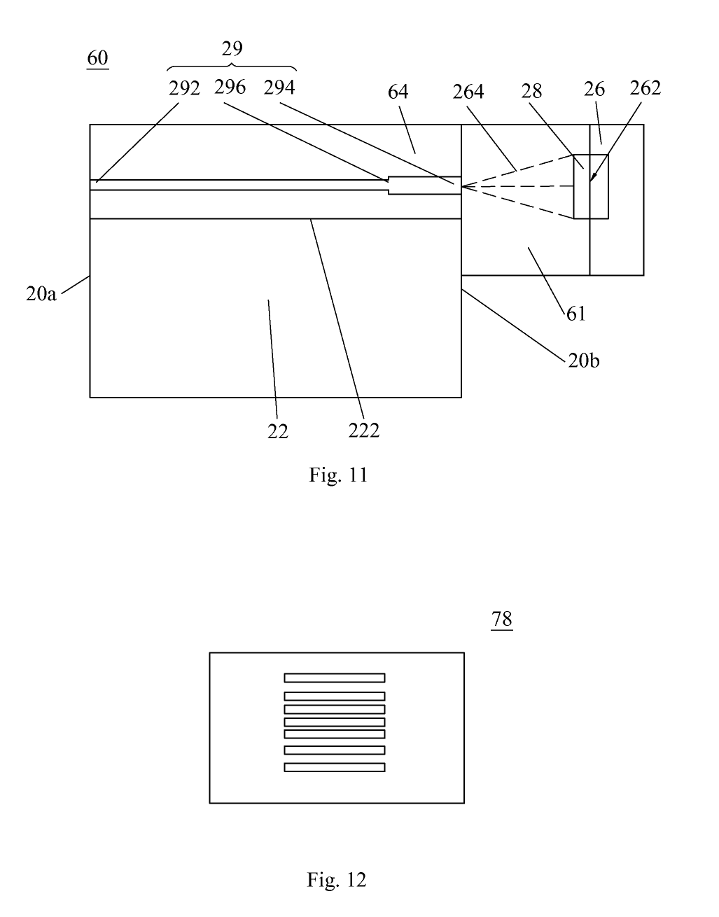

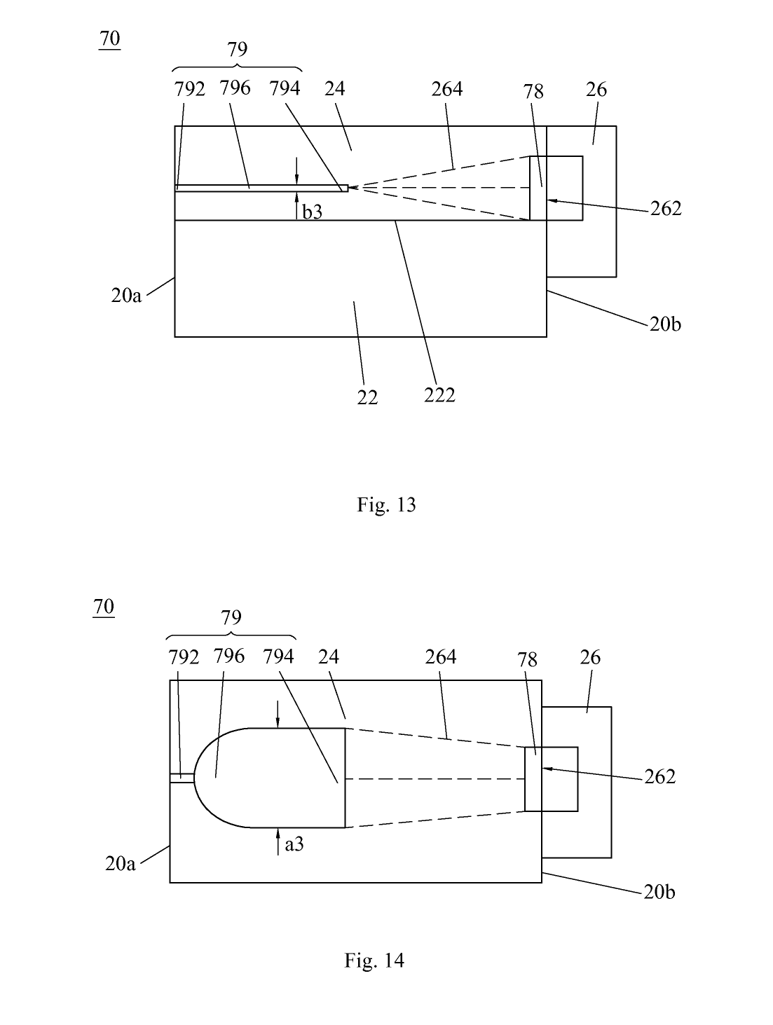

FIG. 11 is again a schematic view of a TAMH slider 60 according to the fifth embodiment of the present invention, a transparent element 61 is formed between the magnetic head portion 64 and the semiconductor surface emitting laser 26, the lens 28 is embedded in the transparent element 61 with a side exposed to the semiconductor surface emitting laser 26, and the incident end 294 of the waveguide 29 extends to the back surface 20b.

FIGS. 12˜14 show a TAMH slider 70 with a different lens 78 and a different waveguide 79, as shown, the lens 78 is constituted by a few bar-shaped grooves, but this type lens 78 just can focus the lights 264 emitted from the semiconductor surface emitting laser 26 in a first direction β1, thus incident end 794 of the waveguide 79 with a 100 μm length a3 and a 0.4 μm width b3 is in a shape of plate to guide the lights 264 in a second direction β2 that is perpendicular to the direction β1. While the middle part 796 of the waveguide 79 is in a shape of a parabola to guide the lights 264 through to the exit end 792 that is same with the waveguide 79 mentioned-above. Concretely, the vertex position of the parabola connects to the exit end 792 and the two sides of the parabola connect to the incident end 794.

By the way, only differences between the TAMH slider 30, 40, 50, 60, 70 and the TAMH slider 20 have been described.

In sum, the performance of the TAMH slider 20˜70 of the present invention is stable, and the light output power is high, thus data can be rapidly written to a magnetic disk 12 with high recording density.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A thermally assisted magnetic head slider, having an air bearing surface and a back surface opposite the air bearing surface, comprising:
a slider substrate;
a magnetic head portion configured on the slider substrate and having a waveguide formed therein;
a semiconductor surface emitting laser configured on the back surface with an emitting surface facing the back surface; and
a lens configured between the semiconductor surface emitting laser and the waveguide for focusing lights emitted from the semiconductor surface emitting laser on an incident end of the waveguide,
wherein the semiconductor surface emitting laser is a vertical cavity surface emitting laser or a photonic crystal surface emitting laser, the lens is a Fresnel lens or a grating lens, and the semiconductor surface emitting laser, the lens, and the waveguide are located linearly.

2. (canceled)

3. The thermally assisted magnetic head slider according to claim 1, wherein the lens is configured on the emitting surface.

4. (canceled)

5. The thermally assisted magnetic head slider according to claim 1, wherein centerlines of the waveguide, the semiconductor surface emitting laser and the lens are overlapped.

6. The thermally assisted magnetic head slider according to claim 1, wherein the incident end of the waveguide is embedded in the magnetic head portion with a predetermined distance between the incident end and the back surface.

7. The thermally assisted magnetic head slider according to claim 1, wherein the lens is formed in the magnetic head portion.

8. The thermally assisted magnetic head slider according to claim 1, wherein the lens and the semiconductor surface emitting laser are formed integrally.

9. The thermally assisted magnetic head slider according to claim 1, wherein the lens is defined as an individual element and formed between the back surface and the emitting surface of the semiconductor surface emitting laser.

10. The thermally assisted magnetic head slider according to claim 8, wherein the incident end of the waveguide is extended to the back surface, and a transparent element is formed between the magnetic head portion and the lens in the semiconductor surface emitting laser.

11. The thermally assisted magnetic head slider according to claim 1, wherein the incident end of the waveguide is extended to the back surface, and the lens is embedded in a transparent element that is formed between the magnetic head portion and the semiconductor surface emitting laser, with a predetermined spacing between the lens and the incident end kept.

12. The thermally assisted magnetic head slider according to claim 1, wherein the waveguide is in a shape of a bar, and the lens is constituted by a few concentric circular grooves.

13. The thermally assisted magnetic head slider according to claim 1, wherein the waveguide is flattened, and the lens is constituted by a few bar-shaped grooves.

14. The thermally assisted magnetic head slider according to claim 1, wherein a focus of the lens and a center of an end face of the incident end are aligned horizontally.

15. A head gimbal assembly, comprising a suspension and a thermally assisted magnetic head slider supported on the suspension, the thermally assisted magnetic head slider having an air bearing surface and a back surface opposite the air bearing surface comprising:
a slider substrate;
a magnetic head portion configured on the slider substrate and having a waveguide formed therein;
a semiconductor surface emitting laser configured on the back surface with an emitting surface facing the back surface; and
a lens configured between the semiconductor surface emitting laser and the waveguide for focusing lights emitted from the semiconductor surface emitting laser on an incident end of the waveguide,
wherein the semiconductor surface emitting laser is a vertical cavity surface emitting laser or a photonic crystal surface emitting laser, the lens is a Fresnel lens or a grating lens, and the semiconductor surface emitting laser, the lens, and the waveguide are located linearly.

16. A disk drive unit, comprising a head gimbal assembly, a drive arm attached to the head gimbal assembly, a disk, and a spindle motor to spin the disk, the head gimbal assembly comprising a suspension and a thermally assisted magnetic head slider supported on the suspension, the thermally assisted magnetic head slider having an air bearing surface and a back surface opposite the air bearing surface comprising:
a slider substrate;
a magnetic head portion configured on the slider substrate and having a waveguide formed therein;
a semiconductor surface emitting laser configured on the back surface with an emitting surface facing the back surface; and
a lens configured between the semiconductor surface emitting laser and the waveguide for focusing lights emitted from the semiconductor surface emitting laser on an incident end of the waveguide,
wherein the semiconductor surface emitting laser is a vertical cavity surface emitting laser or a photonic crystal surface emitting laser, the lens is a Fresnel lens or a grating lens, and the semiconductor surface emitting laser, the lens, and the waveguide are located linearly.

17. A thermally assisted magnetic head slider, having an air bearing surface and a back surface opposite the air bearing surface, comprising:
a slider substrate;
a magnetic head portion configured on the slider substrate and having a waveguide formed therein;
a semiconductor surface emitting laser configured on the back surface with an emitting surface facing the back surface; and
a lens configured between the semiconductor surface emitting laser and the waveguide for focusing lights emitted from the semiconductor surface emitting laser on an incident end of the waveguide,
wherein the lens and the semiconductor surface emitting laser are formed integrally, and
wherein the incident end of the waveguide is extended to the back surface, and a transparent element is formed between the magnetic head portion and the lens in the semiconductor surface emitting laser.

18. A thermally assisted magnetic head slider, having an air bearing surface and a back surface opposite the air bearing surface, comprising:
a slider substrate;
a magnetic head portion configured on the slider substrate and having a waveguide formed therein;
a semiconductor surface emitting laser configured on the back surface with an emitting surface facing the back surface; and
a lens configured between the semiconductor surface emitting laser and the waveguide for focusing lights emitted from the semiconductor surface emitting laser on an incident end of the waveguide,
wherein the incident end of the waveguide is extended to the back surface, and the lens is embedded in a transparent element that is formed between the magnetic head portion and the semiconductor surface emitting laser, with a predetermined spacing between the lens and the incident end kept.

19. The thermally assisted magnetic head slider according to claim 1, wherein the lens is a part of a front mirror of the semiconductor surface emitting laser and is arranged to reduce the incidence of the mode hopping.
